(19) United States
(12) Patent Application Publication
(10) Pub. No.: US 2014/0230211 A1
(43) Pub. Date: Aug. 21, 2014

(54) POWER CUTTER

(71) Applicant: MAKITA CORPORATION, AICHI (JP)

(72) Inventor: Manfred DOERING, Neuhof (DE)

(73) Assignee: MAKITA CORPORATION, Aichi (JP)

(21) Appl. No.: 14/178,441

(22) Filed: Feb. 12, 2014

(30) Foreign Application Priority Data
Feb. 15, 2013 (DE) 202013100690.4

(51) Int. Cl. B23D 47/12

(52) U.S. Cl. CPC B23D 47/12
USPC 29/401.1; 30/276

(57) ABSTRACT

A power cutter includes a housing, a first return pulley borne in a rotating manner in the housing and driven directly by a motor arranged in the housing, a cutting arm connected to the housing has a housing in which a second return pulley is arranged in a rotating manner, and is driven by a tension means guided over the first return pulley and the second return pulley, as well as a cutting tool which can be detachably fastened to the cutting arm, and a method of changing the position of a cutting tool of a power cutter, through which handling during changing the position of the cutting tool can be simplified. For the detachable fastening of the cutting tool, the cutting tool is borne on a shaft, whereby the shaft can be detachable fastened to two opposite sides of the second return pulley.

The present invention relates to a power cutter. The invention also relates to a method of changing the position of a cutting tool of a power cutter.

### PRIOR ART

A power cutter, which can be in the form, for example, of a cutting grinder, stump grinder or a rail cutter, has a cutting arm on which a cutting tool is arranged which is driven by an return pulley arranged in the cutting arm. The cutting arm is connected to a housing of the power cutter in which a motor, more particularly an electric or petrol motor and a further return pulley are arranged, whereby the further return pulley is driven directly by the motor. A tension means, for example a V-belt is applied over the return pulleys and tensioned, which drives the return pulley arranged in the cutting arm and thereby also the cutting tool.

Normally the cutting tool is arranged centrally in relation to the longitudinal axis of the housing of the power cutter, which results is a good centre of gravity which allows optimum guiding of the cutting tool, particularly if the power cutter is designed as a portable power cutter. However, in some cases it is also necessary to arrange the cutting tool on the outer side of the power cutter and thereby eccentrically. This is required, for example, if components project from a wall and have to be cut flush, are being cut to size.

In the known power cutters, the position of the cutting tool is achieved, for example, by releasing the tension means from the return pulleys, unscrewing the cutting arm from the housing, turning it about 180° and after replacing and re-tensioning the tension means on the return pulleys, screwing the cutting arm back on the housing of the power cutter. Due to the required major refitting of the power cutter, changing the position of the cutting tool is very laborious and requires great skill in setting the tension of the tension means after each change of position of the cutting tool.

### DISCLOSURE OF THE INVENTION

It is therefore the objective of the present invention to provide a power cutter and a method of changing the position of a cutting tool of a power cutter, in which handling can be facilitated when changing the position of the cutting tool.

The objective in accordance with the invention is achieved with a power cutter which has a housing, arranged in which is a first return pulley rotatably borne in the housing and driven by motor arranged in the housing, a cutting arm connected to the housing, said cutting arm having a housing in which a second return pulley is rotatably borne and is driven by means of tension means guided over the first and second return pulley, and having a cutting tool which can be detachably fastened to the cutting arm, whereby for detachable fastening of the cutting tool, the cutting tool is arranged on a shaft, whereby the shaft can be detachably fastened to two opposite sides of the second return pulley.

The objective in accordance with the invention is also achieved with a method of changing the position of a cutting tool of a power cutter which has a housing, arranged in which is a first return pulley rotatably borne in the housing and driven by motor arranged in the housing, a cutting arm connected to the housing, said cutting arm having a housing in which a second return pulley is rotatably borne and is driven by means of tension means guided over the first and second return pulley, and having a cutting tool which can be detachably fastened to the cutting arm, whereby for detachable fastening of the cutting tool, the cutting tool is arranged on a shaft, whereby the shaft can be detachably fastened to two opposite sides of the second return pulley

Advantageous further embodiments of the invention are set out in the dependent claims.

The power cutter, which can for example be designed as a hand-held motor-driven power cutter, is characterised by simplified handling both when replacing the cutting tool as well as when changing the position of the cutting tool relative to the housing of the power tool, more particularly when changing the position of the cutting tool between a centric and eccentric arrangement in relation to the longitudinal axis of the housing of the power cutter. Due to the special design of the power cutter no more detachment of the entire cutting arm from the housing is required in order to replace or change the position of the cutting tool. More particularly detachment of the tension means from the return pulleys and the associated step of changing of the position of the return pulleys relative to each other, and as result of this, the renewed tensioning of the tension means after a replacement or position change which otherwise often causes problems and operating errors, is no longer necessary. In this way it is now possible for every user to replace or change the position of the cutting tool and this does not necessarily have to be carried out by a specially trained person. When replacing or changing the position of the cutting tool the axial distance between the return pulleys remains unchanged or constant. For replacing or changing the position of the cutting tool, only the shaft, which is designed as a separate element from the two return pulleys and on which the cutting tool is arranged, has to be detached in that the shaft is detached from the return pulley. The cutting tool remains on the shaft. The shafts allow indirect fastening of the cutting tool to the second return pulley via the shaft, so that direct fastening of the cutting tool to the second return pulley is no longer envisaged here. The second return pulley, which is arranged in the cutting arm, is designed so that the shaft can be detachably fastened on two opposite sides of the second return pulley arranged in the cutting arm, more particularly to two opposite end faces of a shaft of the second return pulley, whereby through rapid and simple repositioning of the shaft together with the attached cutting tool, the position of the cutting tool can be changed relative to the cutting arm and thereby relative to the longitudinal axis of the housing of the power cutting with little effort.

For detachable fastening of the shaft to the second return pulley the shaft can preferably be pushed into a hollow space formed in the return pulley. This can form a secure hold of the shaft in the second return pulley. Through being pushed into a hollow space formed in the second return pulley the shaft can be securely fixed into position in the second return pulley by means of a simple plugging procedure. The hollow space of the second idler forms a defined holder space for the shaft, through which incorrect assembly during replacement or position changing can be avoided. The hollow space is formed on both opposite sides of the second return pulley, so that through insertion into the hollow space the shaft can be attached to the two opposite end faces of the shaft of the second return pulley in which the hollow space is formed. Preferably the hollow space is formed as a through-receptacle in the second return pulley, more particularly in the shaft of the second return pulley and extends between the two sides of the second return pulley/the two end faces of shaft of the second return pulley, on which the cutting tool can be positioned.

The shaft can preferably be fasted to the second return pulley in a positive and/or non-positive manner. A detachable non-positive fastening of the shaft to the second return pulley can be brought about, for example, by means of a screw or a nut. In the assembled, tightened state the nut or screw is preferably openly visible and the user can see it visibly rotating when the cutting tool is operation. This allows improved localisation by the user. A detachable positive connection can be produced by a specially shaped contour in the hollow space of the second return pulley and a counter-contour formed on the shaft into which the contour formed on the second return pulley can engage. The contour on the second return pulley can for example be in the form of an additional recess and the counter-contour on the shaft can for example be in the form of a bulge, which has a shape that matches the recess and can engage in the recess. Alternatively it is also possible for the recess to be formed on the shaft and the bulge on the second return pulley in the vicinity of the hollow space. The recess and the bulge can form a type of toothing for captive fastening of the shaft to the second return pulley.

In order to protect the user from particles of dirt produced through starting up the cutting tool, the power cutter preferably has a protective cover which covers part of the cutting tool. Preferably the protective cover forms one unit with the shaft, wherein the protective cover can have a through-receptacle in which the shaft is captively held.

The captive unit formed by the protective cover with the shaft is preferably detachably connected to the housing of the cutting arm via a holder element. In turn the protective cover can be preferably borne in a rotating manner on the holder element. The holder element can allow simple and rapid fastening of the protective cover on the casing of the cutting arm, particularly when changing the position of the cutting tool, when the position of the protective hood, together with the cutting tools is changed relative to the cutting arm. During position changing the protective cover can remain on the holder element even if the holder element is detached from the housing of the cutting arm and is changed in position relative to the cutting arm and/or relative to the housing of the cutting arm together with the cutting tool. Through being borne in a rotatable manner on the holder element, after each position change of the cutting tool the protective cover can be correctly realigned in order to be able to provide optimum protection against dirt, without hindrance to the cutting tool during operation of the power cutter.

Preferably the holder element is plate-shaped and preferably has at least two fastening pins, which can be introduced into and fastened in receptacles formed on the housing of the cutting arm. Through the plate-shaped design of the holder element, the holder element only requires a small amount of axial space and at the same time has as large a contact surface as possible for the protective cover and housing of the cutting arm in order to prevent tilting movements. The fastening pins, which can be formed in one piece with the holder element, or can also be screwed into the holder element are essentially aligned perpendicularly to the plane of the plate-shaped holder element so that through insertion into receptacles formed on the housing of the cutting arm they allow the holder element to lie flat on the housing of the cutting arm. Through the fastening pins and the receptacles the holder element can be rapidly and simply fastened to the housing of the cutting arm. Fastening of the fastening pins inserted into the receptacles can take place, for example, by screwing a nut onto the ends of the fastening pins projecting through the receptacles. Alternatively it is also possible for one or more nuts to be welded onto the holder element and fastening of the holder element to the cutting arm to take place by way of long screws which can be screwed into the nuts welded on the holder element.

The holder element can also have a recess for the shaft on which the cutting tool is arranged to be passed through, whereby the shaft can preferably be held in two different positions in the recess, whereby in a first position with the cutting tool not fastened to the cutting arm the shaft can be held captively in the recess, and in a second position with the cutting tool fastened to the cutting the shaft can be borne friction-free in the recess. The holder element, via the recess which can be formed as a through-opening, is connected to the shaft, on which the cutting arm is arranged. When changing the position of the cutting arm via the shaft, the holder element, as a single unit with the shaft, can be changed in position without the holder element having to be separated from the shaft. This obviates the laborious joining of the holder element to the shaft during or after changing the position of the cutting arm. For this, when the cutting tool is not fastened, i.e. when the cutting tool is detached from the cutting arm for its position to be changed, the shaft is held captively in the recess of the holder element in that there is a loose connection between the shaft and the holder element via the recess. Once the cutting tool has been mounted/fastened back on the cutting arm the shaft is borne in a friction-free manner in the recess of the holder element so that there is no contact between the shaft and the holder element which prevents hindrance to the shaft during a rotary movement of the shaft during operation of the cutting tool/the power cutter.

For defined positioning of the protective cover relative to the cutting arm, an adjustment range limiter can be arranged between the protective cover and the holder element and/or between the protective cover and the housing of the cutting arm. The adjustment range limiter restricts the turning movement of the protective cover so that when the cutting tool is mounted and, in particular, during operation of the power cutter/the cutting tool turning of the protective cover can be prevented. To form the adjustment range limiter an outwardly projecting moulding can be formed onto, or an outwardly projecting element can be attached to the protective cover, more particularly on an outer surface of the protective cover, which can interact with the holder element and/or the housing of the cutting arm. The protective cover, the holder element and the adjustment range limiter on the protective cover are preferably symmetrical so that when changing the position of the cutting tool, in addition to loosening and refastening the cutting tool and the holder element, only an adjusting handle and/or a water set arranged on the protective cover have to be repositioned.

In order to make changing of the position of the cutting tool particularly simple, it is preferably envisaged that the cutting tool, the protective cover and the holder element are captively connected to each other and form a unit which can be detached from the cutting arm. When changing the position of the cutting tool, the cutting tool can therefore be detached from the cutting arm together with the holder element and the protective cover, whereby, however, the holder element and the protective cover are not separated from one another and therefore also do not have to be reassembled. When changing position, the cutting tool together with the shaft, the protective cover and the holder element form one unit, which together as one unit can have their position changed on the cutting arm as one unit. During a position change only the shaft, on which the cutting tool is borne, has to be repositioned in the second return pulley and refastened to the return pulley and the holder element refastened on the housing of the cutting arm, whereby both the shaft and the holder element can be fastened to and unfastened from the cutting arm by means of a screw connection, as a result of which handling is considerably simplified for the user and the risk of incorrect assembly is considerably reduced.

### PREFERRED EXAMPLES OF EMBODIMENT

With the aid of the figures, further measures that improve the invention are set out in more detail below together with a description of preferred examples of embodiment of the invention.

In these:

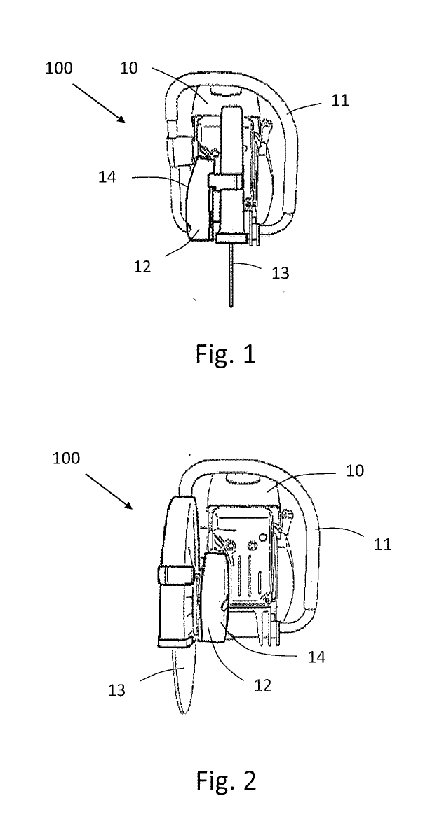

FIG. 1 shows a schematic view of a power cutter with a cutting tool in a first position in accordance with the invention,

FIG. 2 shows a schematic view of a power cutter with a cutting tool in a second position in accordance with invention,

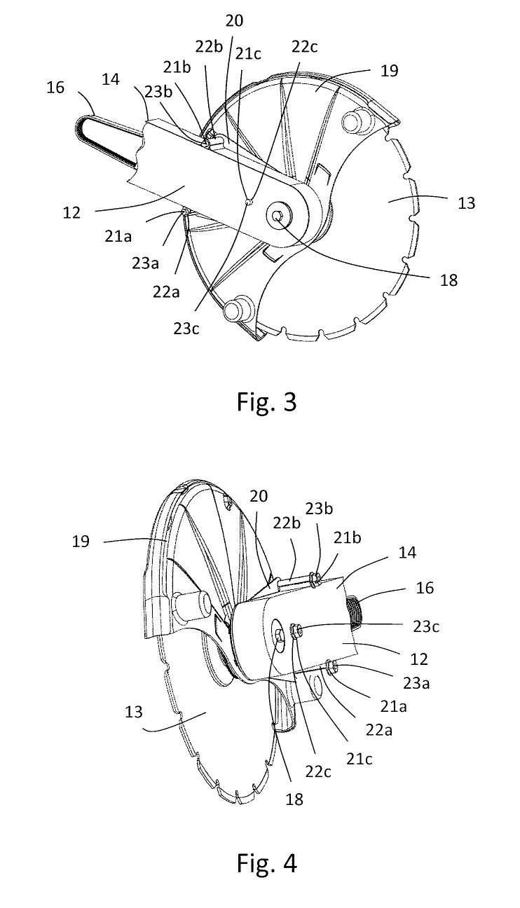

FIG. 3 shows a schematic view of a cutting arm of a power cutter according to FIG. 1 with a cutting tool in the first position in accordance with invention,

FIG. 4 shows a schematic view of a cutting arm of a power cutter according to FIG. 2 with a cutting tool in the second position in accordance with invention,

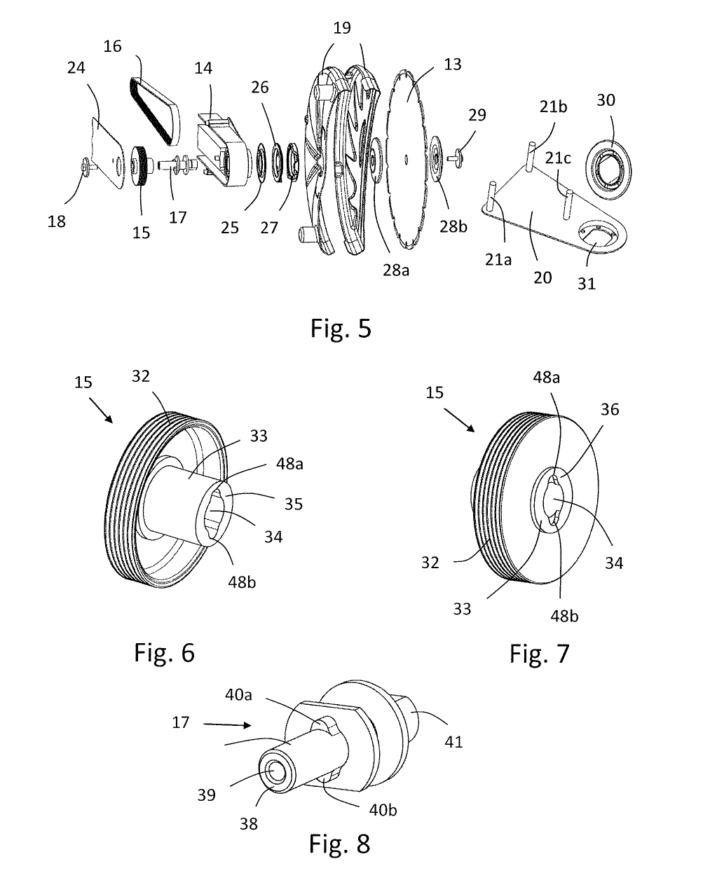

FIG. 5 shows an exploded view of a cutting arm of a power cutter with a cutting tool in accordance with invention,

FIG. 6 schematically shows a first view of a second return pulley of the power cutter in accordance with invention,

FIG. 7 schematically shows a second view of the second return pulley of the power cutter in accordance with invention,

FIG. 8 shows a schematic view of a shaft the power cutter in accordance with invention for holding the cutting tool and for arrangement on the second return pulley,

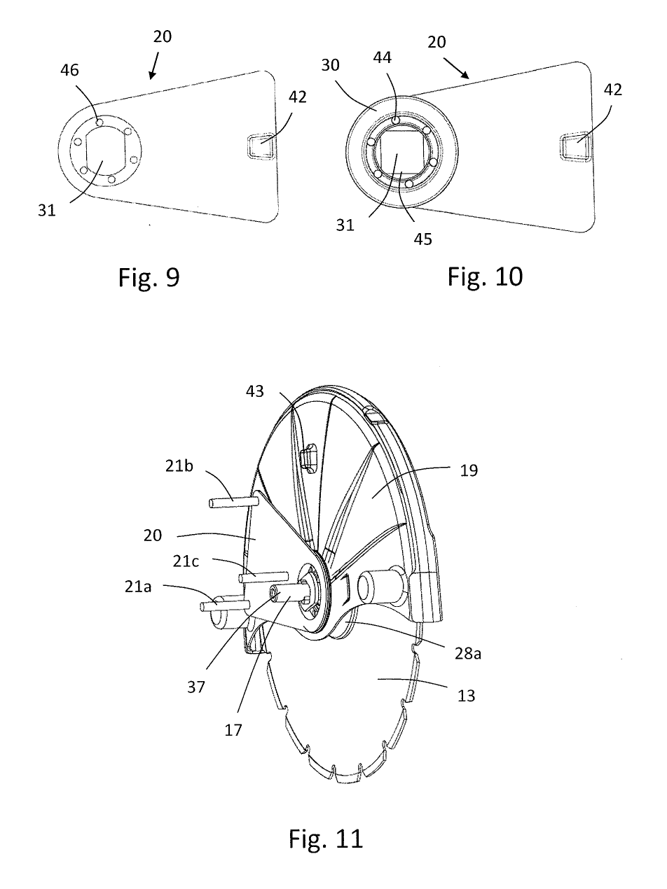

FIG. 9 shows a schematic view of a holder element of the power cutter in accordance with invention,

FIG. 10 shows a schematic view of the holder element shown in FIG. 9 with a fastening flange arranged thereon,

FIG. 11 shows a schematic view of the cutting tool with the holder element and a protective cover as a detachable unit,

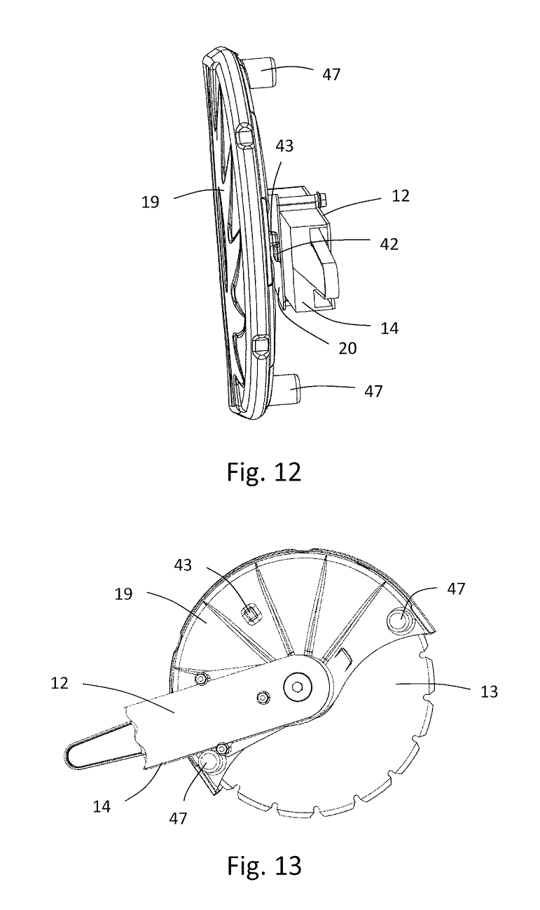

FIG. 12 shows a further schematic view of the cutting arm of the power cutter with the cutting tool in accordance with invention, and

FIG. 13 shows a further schematic view of the cutting arm of the power cutter with the cutting tool in accordance with invention.

FIG. 1 shows a power cutter 100 in accordance with invention with a housing 10, in which a motor, not shown here, and a first return pulley, not shown here, are arranged, whereby the first return pulley is directly driven by the motor when the power cutter 100 is operated. On the outside of the housing 10 a handle 11 is arranged for holding and carrying the power cutter 100.

The power cutter 100 has a cutting arm 12, arranged on which is a cutting tool 13, for example in the form of a cutting disk. The cutting arm 12 has a housing 14, which can be designed in one piece with the housing 10 of the power cutter 100 or can be designed as a separate component.

In the view shown in FIG. 1, the cutting tool 13 is arranged in a first position in relation to the cutting arm 12, whereby in this first position the cutting tool 13 is arranged centrically in relation to the longitudinal axis of the housing 10 of the power cutter 100.

FIG. 2 also shows the power cutter 100 shown in FIG. 1, whereby here the position of the cutting tool 13 has been changed so that it is now in a second position relative to the cutting arm 12, whereby in this second position the cutting tool 13 is arranged eccentrically in relation to the longitudinal axis of the housing 10 of the power cutter 100.

In FIG. 3 a cutting arm 12 is shown with a cutting tool 13 arranged thereon in the first position. Borne in rotating manner in the housing 14 of cutting arm 12 is a second return pulley 15 as shown in FIGS. 6 and 7, which can be driven by means of a tension means 16, for example a V-belt, guided over the first return pulley and the second return pulley 15. The cutting tool 13 is borne on a shaft 17 as shown in FIG. 8, whereby the shaft 17 is detachably fastened to the second return pulley 15 in order to be able to drive the cutting tool 13 via the second return pulley 15 during operation of the power cutter 100. The shaft 17 thereby forms a connection between the second return pulley 15 and the cutting tool 13 so that here the cutting tool 13 is not connected directly, but indirectly to the second return pulley 15. The shaft 17 can be fastened to the second return pulley 15 by means of screw 18, as a result of which a detachable non-positive connection can be formed. The screw 18 is accessible from the outside of the housing 14 of the cutting arm 12 so that with little effort a user can loosen the connection between the second return pulley 15 and the shaft 17 by undoing the screw 18 as a result of which when loosening and detaching the shaft 17 from the second return pulley 15 and thereby the cutting arm 12, the cutting tool 13 can also be loosened and detached.

In order to prevent dirt penetrating into the power cutter 100 a protective cover 19 is provided which covers a section of the cutting tool 12. Die protective cover 19 detachably connected to the housing 14 of the cutting arm 12 via a plate-shaped holder element 20. The protective cover 19 is borne on the holder element 20 in a rotating manner so that when changing the position of the cutting tool 13, and thereby also of the protective cover 19, the protective cover 19 can be turned back into the correct position relative to the cutting arm 12. The holder element 20 is attached to the housing 14 of the cutting arm 12 via three fastening pins 21a, 21b, 21c, as shown in FIG. 5, which pass through receptacles 22a, 22b, 22c formed on the housing 14 of the cutting arm 12 and are secured with a nut 23a, 23b, 23c. In the embodiment shown here the receptacles 22a, 22b, 22c are in the form of two sleeve bodies 22a, 22b, provided on opposite side faces of the housing and in the form of a bored hole 22c passing through the housing 14 of the cutting arm 12.

In order to change the position of the cutting tool 13 on the cutting arm 12, the nuts 23a, 23b, 23c and the screw 18 are loosened so that the holder element 20 together with the protective cover 19 and the shaft 17 together with the cutting tool 13 can be detached and removed from the cutting arm 12, in order to then be jointly attached again as a unit on the opposite side of the cutting arm 12, as shown in FIG. 4, in that the fastening pins 21a, 21b, 21c are inserted into the receptacles 22a, 22b, 22c and fastened with the nuts 23a, 23b, 23c and the shaft 17 is pushed into the second return pulley 15 and fastened on the opposite outer side of the housing 14 of the cutting arm 12 with the screw 18.

FIG. 5 shows an exploded view of the individual components of the cutting arm 12 and cutting tool 13 shown in FIGS. 3 and 4, with the screw 18 for fastening the shaft 17, with a housing cover 24 for closing the housing 14 of the cutting arm 12, with the second return pulley 15, with the tension means 16, with several tensioning flanges 25, 26, 27, with the protective cover 19, which is designed in two parts, with two half shells 28a, 28b, each arranged between a side surface of the cutting tool 13 and a part of the protective cover 19, with a screw for the torsion-proof fastening of the cutting tool 13 on the shaft 17, with the holder element 20 and the fastening pins 21a, 21b, 21c arranged thereon in the shape of a triangle and with an fastening flange 20 which can be fastened to the holder element 20, whereby the fastening flange 30 can be arranged in the area of a recess 31 of the holder element 20 through which the shaft 17 can be passed.

FIGS. 6 and 7 show two different views of the second return pulley 15, which is arranged in the housing 14 of the cutting arm 12. The return pulley 15 has a circular circumferential outer surface on which the tension means 16 lies in order to rotate the return pulley 15. In a rotationally symmetrical manner to the circumferential outer surface 32, the return pulley 15 has a shaft 33, whereby the circumferential outer surface 32 surrounds the shaft 33 at a distance from the shaft 33. The shaft 33 has a hollow space 34 in the form of a through-opening extending from one end surface 35 of the shaft 33 to an opposite end surface 36 of the shaft 33. The shaft 17, on which the cutting tool 13 is fastened, can be introduced into and fastened in this hollow space 34. As the hollow space 34 is in the form of a through-opening and extends from one end surface 35 to the opposite end surface 36 of the shaft 33, shaft 17, through turning shaft 17 about 180° can be introduced into and fastened in the hollow space 34 via both end surface 35, 36, i.e. from the right and from the left of the return pulley 15, whereby the position of the cutting tool 13 on the cutting arm 12 can be changed without the position of the second return pulley 15 having to be changed, and, more particularly, without the need to remove the tension means 16 from its tension position.

In order, in addition to the non-positive fastening, to be able to bring about a positive fastening of the shaft 17 on the second return pulley 15, a contour is provided in the form of two opposite recesses 48a, 48b in the hollow space 34 of the second return pulley 15 which can interact with a counter-contour formed on the shaft 17.

A shaft 17, on which the cutting tool 13 is fastened is shown in FIG. 8. The shaft 17 has a first end 37, with which the shaft 17 can be introduced into and fastened in the hollow space 34 of the second return pulley 15. At the end face 38 of the first end 37 of the shaft 17 there is a threaded hole 39, into which the screw 18 for torsion-proof fastening of the shaft 17 on the second return pulley 15 can be screwed. In the region of the first end 37, on the circumferential outer surface of the shaft 17 there is also a counter-contour to the contour formed in the hollow space 34 of the second return pulley 15, whereby here the counter-counter is in the form of two opposite bulges 40a, 40b which can engage in the recesses 48a, 48b in order to form a positive toothing and thus a type of captive fastening.

The holder element 20, the protective cover 19 and the cutting tool 12 can be fastened on a first end 37 opposite the second end 41 of the shaft 17. On the end surface of the second end 41 of the shaft 17 there is also a threaded hole, which is not visible here, into which the screw 39 for the torsion-proof 39 fastening of the cutting tool 13 to the shaft 17 can be screwed.

In FIGS. 9 and 10 the plate-shaped holder element 20 is shown in a view from above of a side surface of the holder element 20, which in the assembled state faces the outer surface of the protective cover 19 and does not constitute the sides surface of the holder element 20 on which the fastening pins 21a, 21b, 21c are arranged in order to fasten the holder element 20 to the cutting arm 12. On the side surface of the holder element 20 shown here, opposite the recess 31 for passing the shaft 17 through the holder element 20, there is moulding or bulge 42 projecting from the side surface which can interact with a moulding or bulge 43, as shown in FIGS. 11 and 12, in order to provide an adjustment range limiter between the protective cover 19 and the holder element 20.

In FIG. 10 the fastening flange 30 is arranged on the holder element 20 in the region of recess 31, whereby on the holder element 20 and the fastening flange 30 several drilled holes 46, 44 are provided via which the fastening flange 30 can be fastened to the holder element 20 by means of a screw connection. Like the holder element 20, the fastening flange 30 has a recess 45 which can be aligned with the recess 31 of holder element 20 when arranging the fastening flange 30 on the holder element 20. By means of the fastening flange 30 the type of bearing of the shaft 17 in the recess 31 can be adjusted, whereby in a first position in a non-fastened or non-assembled state of the cutting tool 13 on the cutting arm 12 the shaft 17 is captively held in the recess 31, and in second position in a fastened or assembled state of the cutting tool 13 on the cutting arm 12 the shaft is held in a friction-free manner in the recess 31 and more particularly can rotate without friction.

FIG. 11 shows the cutting tool 13 fastened on the shaft 17, the protective cover 19 and the holder element 20 as a captively connected unit which can be moved into any position on the cutting arm 12 between the two positions shown in FIG. 1 and FIG. 2, in that with its first end 37 the shaft 17 is pushed into the hollow space 34 of the second return pulley 15 and screwed tight with the screw 18 and the fastening pins 21a, 21b, 21c of the holder element 20 are inserted into the receptacles 22a, 22b, 22c on the cutting arm 12 and fastened there by means of nuts 23b, 23c.

FIGS. 12 and 13 show a further view of a cutting arm 12 with a cutting tool 13 arranged thereon, whereby in particular, in each case an adjustment range limiter for the defined positioning of the protective cover 19 relative to the cutting arm 12 is shown.

In FIG. 12 an adjustment range limiter is shown which is provided between the protective cover 19 and the holder element 20. Here, the adjustment range limiter is formed by the moulding 42 formed on the holder element 20 and the moulding 43 formed on the protective cover 19, which in the assembled state of the cutting tool 13 on the cutting arm 12 face each other and come into contact, as a result of which a turning movement of the protective cover 19 relative to the holder element 20 or to the housing 14 of the cutting arm 12 is restricted to a downward direction.

In the form of embodiment shown in FIG. 13 the adjustment range limiter is formed between the protective cover 19 and the housing 14 of the cutting arm 12, whereby for this from the outer surface of the protective cover 19 a moulding or limiting element 47, is formed, here in the form of a cylinder, which during a turning movement of the protective cover 19 hits the housing 14 of the cutting arm 12 and can thus prevent further turning of the protective cover 19. In the embodiment shown here two limiting elements 47 are arranged opposite each other on the protective cover 19.

As shown in the illustrated embodiments, it is possible for means for forming an adjustment range limiter with the holder element 20 and the housing 14 of the cutting arm 12 to be provided on the protective cover 19. The protective cover 19 shown here has both a moulding 43 for interacting with a moulding 42 on the holder element, as well as a limiter element 47 for interacting with the housing 14 of the cutting arm 12.

The invention is not restricted in its implementation to the preferred examples of embodiment set out above. Rather, a number of variants are conceivable, which make use of fundamentally different types of embodiment from the shown solution. All the features and/or advantages set out in the claims, the description and the drawings, including structural details, spatial arrangements and process stages can be essential for the invention in themselves and also in the most varied of combinations.

### REFERENCE LIST

100 Power cutter

10 Housing

11 Handle

12 Cutting arm

13 Cutting tool

14 Housing

15 Second return pulley

16 Tension means

17 Shaft

18 Screw

19 Protective cover

20 Holder element

21a, 21b, 21c Fastening pin

22a, 22b, 22c Receptacle

23a, 23b, 23c Nut

24 Housing cover

25 Tensioning flange

26 Tensioning flange

27 Tensioning flange

28a, 28b Half shell

29 screw

30 Fastening flange

31 Recess

32 Circumferential outer surface

33 Shaft

34 Hollow space

35 End surface

36 End surface

37 First end

38 Face end

39 Threaded hole

40a, 40b Bulge

41 Second end

42 Moulding

43 Moulding

44 Drilled hole

45 Recess

46 Drilled hole

47 Limiter element

48a, 48b Recess

1. Power cutter, with a housing,
a first return pulley borne in a rotating manner in the housing and driven directly by a motor arranged in the housing,
a cutting arm, which is connected to the housing, and has a housing in which a second return pulley is arranged in a rotating manner, and is driven by a tension means guided over the first return pulley and the second return pulley, as well as
a cutting tool which can be detachably fastened to the cutting arm, whereby for detachable fastening of the cutting tool the cutting tool is borne on a shaft, whereby the shaft can be detachably fastened to two opposite sides of the second return pulley.

2. Power cutter according to claim 1, characterised in that for detachably fastening the shaft to the second return pulley the shaft can be inserted into a hollow space which is formed on the second return pulley.

3. Power cutter according to claim 1, characterised in that the shaft can be detachably fastened to the second return pulley in a positive and/or non-positive manner.

4. Power cutter according to any one of claim 1, characterised in that the power cutter has a protective cover which covers sections of the cutting tool.

5. Power cutter according to claim 4, characterised in that the protective cover can be detachably fastened via a holder element to the housing of the cutting arm, whereby the protective cover is borne on the holder element in a rotating manner.

6. Power cutter according to claim 5, characterised in that the holder element is plate-shaped and has at least two fastening pins which can be inserted into and fastened in receptacles provided on the casing of the cutting arm.

7. Power cutter according to claim 5, characterised in that, the holder element has a recess for the shaft to be passed through, whereby the shaft can be held in the recess in two different positions, whereby in a first position in a non-fastened state of the cutting tool on the cutting arm the shaft is captively held in the recess and in a second position in a fastened state of the cutting tool on the cutting arm the shaft is held in the recess in a friction-free manner.

8. Power cutter according to claim 4, characterised in that between the protective cover and the holder element and/or between the protective cover and the housing of the cutting arm there is an adjustment range limiter for defined positioning of the protective cover relative to the cutting arm.

9. Power cutter according to claim 5 characterised in that the cutting tool, the protective cover and the holder element are captively connected to each other and form a unit that can be detached from the cutting arm.

10. Method of changing the position of a cutting tool of a power cutter which has with a housing, a first return pulley borne in a rotating manner in the housing and driven directly by a motor arranged in the housing, a cutting arm, which is connected to the housing, and has a housing in which a second return pulley is arranged in a rotating manner, and is driven by a tension means guided over the first return pulley and the second return pulley, as well as a cutting tool which can be detachably fastened to the cutting arm, whereby for detachable fastening of the cutting tool the cutting tool is borne on a shaft, whereby the shaft can be detachably fastened to two opposite sides of the second return pulley.
